(19) United States
(12) Patent Application Publication
(10) Pub. No.: US 2025/0064223 A1
(43) Pub. Date: Feb. 27, 2025

(54) COMPOSITE CUSHION AND CUSHION FORMING MOLD

(71) Applicant: EWAY TRADING (HANGZHOU) CO., LTD., Hangzhou City (CN)

(72) Inventor: Jianguo WU, Hangzhou City (CN)

(73) Assignee: EWAY TRADING (HANGZHOU) CO., LTD., Hangzhou City (CN)

(21) Appl. No.: 18/507,887

(22) Filed: Nov. 13, 2023

(30) Foreign Application Priority Data
Aug. 23, 2023 (CN) 202322272298.9

(51) Int. Cl. A47C 27/14; A47C 27/15

(52) U.S. Cl. CPC A47C 27/148; A47C 27/15

(57) ABSTRACT

A composite cushion and a cushion forming mold are provided in the disclosure, which relates to the technical field of cushion structures. The composite cushion includes a first cushion body and a second cushion body. The second cushion body is provided with a wrapping sealing edge, and the wrapping sealing edge is bent in a direction towards a middle to form a wrapping cavity with an opening larger than an inner cavity. The first cushion body is located in the wrapping cavity, and the second cushion body is configured to wrap the first cushion body. The first cushion body and the second cushion body are integrally formed in a foaming manner, and materials and/or densities of the first cushion body and the second cushion body are different. The integrated composite cushion according to the disclosure has advantages of good comfort and no adhesive, and being safe and odorless.

### CROSS-REFERENCE TO RELATED APPLICATION

This Non-provisional application claims priority under 35 U.S.C. § 119(a) to Chinese Patent Application No. 202322272298.9, filed on 23 Aug. 2023, the entire contents of which is hereby incorporated by reference in its entirety.

### TECHNICAL FIELD

The disclosure relates to the technical field of cushion structures, in particular to a composite cushion and a cushion forming mold.

### BACKGROUND ART

Due to accelerated pace of life, people need to stay in a sitting position for a long period in their study and working. Sedentary, especially with inappropriate sitting postures, may exert a strong pressure on the spine and its connected ligaments and muscles, resulting in backache, even spinal pain and deformity. Cushions and back cushions can be adopted to provide support, thus improving comfort and reducing adverse effect caused by sedentary as much as possible, which are widely used in sofas, chairs, office chairs and other products.

Existing cushions are usually made of a single soft material, which exhibit a low support factor and poor durability after repeated compression, and are prone to lacking elasticity and bulkiness after long-term use. In addition, some cushions adopt a multi-layer composite structure, and respective layers are stacked up and down sequentially, and connected by an adhesive. Although defects of a single material cushion can be overcome, the multi-layer composite structure has poor integrity, and it is difficult to achieve environmental protection and no pollution when using the adhesive.

### SUMMARY

In view of above problems, an integrated composite cushion with good comfort and no adhesive and a forming mold for the cushion are provided in this disclosure.

Technical schemes adopted by the disclosure are as follows. A composite cushion is provided in this disclosure, which includes a first cushion body and a second cushion body. The second cushion body is provided with a wrapping sealing edge, and the wrapping sealing edge is bent in a direction towards a middle to form a wrapping cavity with an opening larger than an inner cavity. The first cushion body is located in the wrapping cavity, and the second cushion body is configured to wrap the first cushion body. The first cushion body and the second cushion body are integrally formed in a foaming manner, and materials and/or densities of the first cushion body and the second cushion body are different.

The first cushion body and the second cushion body are made of different materials and/or with different densities, and one of the cushion bodies can provide a supporting function, so that the composite cushion can generate a good supporting force with the first cushion body and can effectively support a user's body. The other of the cushion bodies is made of a softer material, so that the composite cushion can produce good somatosensory comfort with this flexible support body, with good contact comfort of users. The formed composite cushion has a soft side and a hard side, and provides different choices under different use requirements, with the soft side or the hard side facing upwards, thus enriching applicability of the product.

The first cushion body and the second cushion body are integrally formed in a foaming manner, with good integrity and no adhesive for bonding, which is safe, odorless and environment-friendly. The second cushion body is configured to wrap the first cushion body through a bending structure of the wrapping sealing edge, so that an integrated structure between the first cushion body and the second cushion body is more firm and reliable.

Optionally, the first cushion body is a sponge body and the second cushion body is a memory form body. The memory form body has slow resilience, which, due to its open cell structure, is with softer feeling and more comfortable, and can move under action of an external force, and thus the force can be dispersed to fit the whole contact surface, creating a “zero pressure” feeling, reducing discomfort caused by contact and extrusion with the cushion, and promoting blood circulation of a human body. Moreover, the soft memory form body completely covers a whole surface of the sponge body, so that the user can completely contact with the memory form body without contacting with the first cushion, with good comfort.

Optionally, a density of the sponge body is 25 to 60 kg/m³, and the sponge body has certain hardness and resilience, which can provide good support. A density of the memory form body is 30 to 100 kg/m³, with a material being soft and comfortable. The first cushion body 1 can be a sponge body with a density of 25 to 60 kg/m³, and a 65% indentation hardness of the first cushion body 1 is 200 to 850 N. The second cushion body 2 can be a memory form body with a density of 30 to 100 kg/m³, and a 65% indentation hardness of the second cushion body 2 is 80 to 200 N.

Optionally, the first cushion body is a sponge body, and the second cushion body is a latex-imitated sponge body. The latex-imitated sponge body has a cellular structure with all of or most of holes connected, which is soft in material, with high elasticity, comfort and durability.

Optionally, a density of the sponge body is 25 to 60 kg/m³, and the sponge body has certain hardness and resilience, which can provide good support. A density of the latex-imitated sponge body is 30 to 100 kg/m³, which is with a soft material and comfort. The first cushion body 1 can be a sponge body with a density of 25 to 60kg/m³, and a 65% indentation hardness of the first cushion body 1 is 200 to 850 N. The second cushion body can be a latex-imitated sponge body of 30 to 100 kg/m³, with a 65% indentation hardness of 65 to 180 N.

Optionally, a thickness of the sponge is one-third to six out of seven of an overall thickness of the composite cushion. The first cushion body can give enough support, and at the same time, it also shapes an overall shape of the composite cushion, so that the composite cushion is not easy to deform and fail after long-term use on a premise of satisfying comfort.

Optionally, the second cushion body is integrally formed with the wrapping sealing edge by foaming, with good integrity and a simple manufacturing process.

Optionally, a folding width of the wrapping sealing edge is uniform, with a smooth and aesthetic structure as a whole.

A cushion forming mold is further provided in the disclosure, which is configured for forming a composite cushion and includes an upper mold and a lower mold. A middle part of an upper side of the lower mold is recessed inward to form an accommodating cavity, a lower side of the upper mold is provided with a convex part which is matched with an opening of the accommodating cavity to form a closed cavity for foaming, and the upper mold and/or the lower mold are provided with a plurality of positioning members located in the accommodating cavity. The composite cushion includes a first cushion body and a second cushion body, and materials and/or densities of the first cushion body and the second cushion body are different. After a preformed first cushion body is positioned by the positioning members, the second cushion body is foamed, and the formed second cushion body can form an integrated structure with the first cushion body.

The first cushion body is disposed into a foaming chamber in advance. If the first cushion body is not fixed by the positioning members, when a material for foaming the second cushion body is injected into the foaming chamber through a mold hole, an impact force during foaming may result in irregular displacement of the first cushion body in the accommodating chamber, which further results in uneven distribution of the formed second cushion body on a surface of the first cushion body and affect product quality. Therefore, before the second cushion body is foamed and formed, the first cushion body is inserted on the plurality of positioning members for positioning in advance, so that the first cushion body can be prevented from being displaced, and the second cushion body is more evenly distributed on the surface of the first cushion body. In addition, in order to be aesthetic and ensure comfort when used on both sides, a size of the first cushion body is appropriately cut smaller, so that a gap is left between the first cushion body and an inner wall of the accommodating cavity, and the second cushion body is formed at the gap by foaming, and a foaming material is uniformly wrapped around the first cushion body, thus forming an integrated structure that wraps the first cushion body.

Specifically, forming of the composite cushion in the mold includes following steps:
step 1: preheating the lower mold with warm water of 40 to 50° C. until a temperature inside the accommodating cavity reaches about 36° C.;
step 2: inserting the first cushion body into the positioning members of the upper mold for fixing, after the first cushion body is cut;
step 3, injecting a certain amount of foaming material for the second cushion into the accommodating cavity, and closing the upper mold to ensure that the foaming cavity is in a sealed state, so that the foaming material fully reacts and is fully integrated with the first cushion body until the foaming material is foamed and molded, and wrapped around the first cushion body;
step 4: after the foaming is completed, opening the upper mold after cooling the mold and taking out products for checking and trimming; and
step 5: placing a composite cushion that has passed the checking and trimming on a shelf and naturally curing for more than 24 hours.

Main materials for foaming are MDI (diphenylmethane diisocyanate) and Polyether (polyether) and a trace amount of foaming catalyst. Specifically, different proportions can be adjusted according to different densities and hardness.

Optionally, the convex part is an irregular annular structure adapted to the opening of the accommodating cavity. The plurality of positioning members are fixedly arranged on the lower side of the upper mold and are located in a ring of the convex part. When the first cushion body is fixed on the positioning members, a gap can be left between the first cushion body and the lower side of the upper mold, which facilitates foaming and demolding of the foaming material.

Optionally, the opening of the accommodating cavity is provided with a smooth introduction surface that expands outward, and an outer edge of the convex part is a smooth insertion surface that tapers inward, so that the convex part can quickly and smoothly seal the opening of the accommodating cavity, which also facilitates formation of an interference fit structure between the introduction surface and the insertion surface so as to ensure sealing.

Optionally, the plurality of positioning members are symmetrically and oppositely arranged in pairs, and the first cushion body can be inserted on the positioning members in a balanced and stable manner, and an impact force during foaming may cause no displacement of the first cushion body.

Optionally, the lower side of the upper mold and the upper side of the lower mold are also respectively provided with an inserting post and an inserting slot for assisting in positioning and fixing. A structure provided with the inserting post and the inserting slot can be further positioned, so that the upper mold and the lower mold will not be displaced due to the impact force during the foaming, thus preventing the foaming material from overflowing and affecting product quality.

Alternatively, the inserting post is a structure tapered towards its free end and the inserting slot is a structure expanded towards its notch, which facilitates quick positioning between the inserting post and the inserting slot.

The composite cushion has beneficial effects that the composite cushion is made of the first cushion body and the second cushion body with different materials and/or densities, and one of the cushion bodies can provide support, and the other of the cushion bodies is soft in material, which is in contact with users and has good comfort. The first cushion body and the second cushion body are integrally formed in a foaming manner, with no adhesive for bonding, which is safe, odorless and environment-friendly. The second cushion body is configured to wrap the first cushion body through a bending structure of the wrapping sealing edge, so that an integrated structure between the first cushion body and the second cushion body is more firm and reliable.

### BRIEF DESCRIPTION OF THE DRAWINGS

FIG. 1 is a schematic view of a structure of a reverse side of a composite cushion according to an embodiment;

FIG. 2 is a schematic view of an inner structure of a reverse side of a composite cushion according to an embodiment;

FIG. 3 is a schematic view of an inner structure of a positive side of a composite cushion according to an embodiment; and

FIG. 4 is a schematic structural diagram of a cushion forming mold according to an embodiment.

Reference numbers in the figure are as follows: 1. First Cushion Body; 2. Second Cushion Body; 21. Wrapping Sealing Edge; 22. Wrapping Cavity; 3. Mold; 31. Upper Mold; 32. Lower Mold; 33. Positioning Member; 311. Convex Part; 312. Insertion Surface; 313. Inserting Post; 321. Accommodating Cavity; 322, Introduction Surface; 323. Inserting Slot.

### DETAILED DESCRIPTION

In the following, a detailed and complete description of the present disclosure will be made in combination with specific embodiments with reference to the drawings.

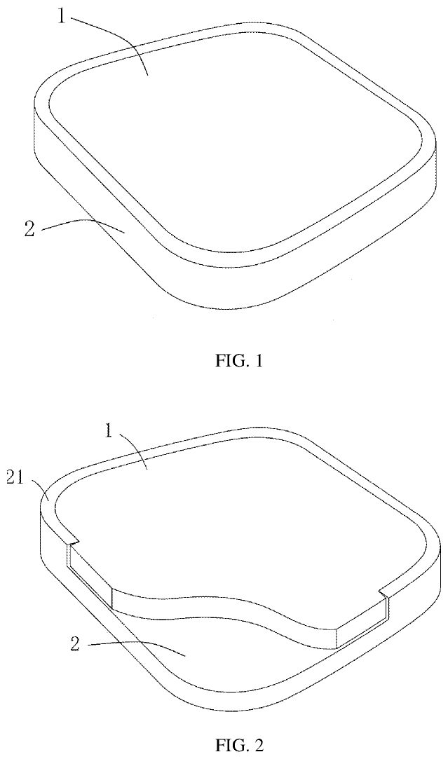

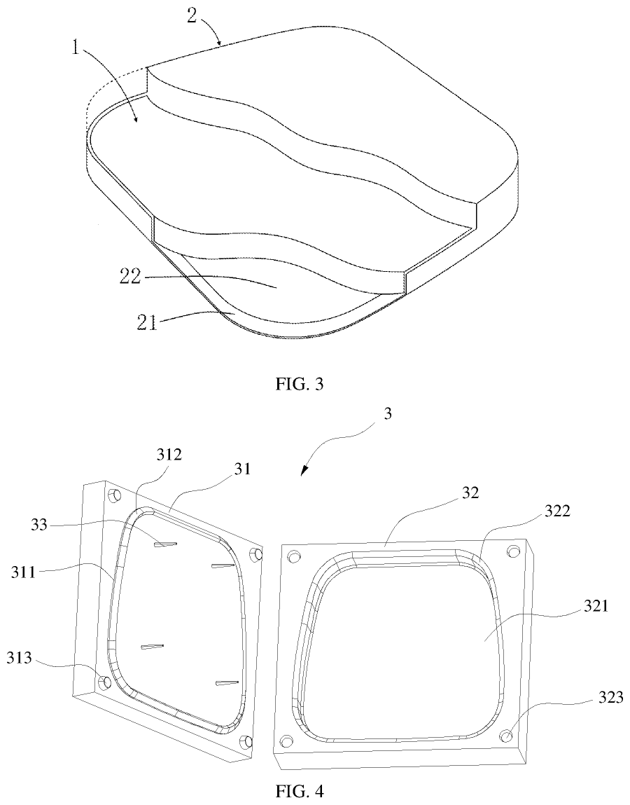

Referring to FIGS. 1 to 3, a composite cushion is provided in this disclosure, which includes a first cushion body 1 and a second cushion body 2.

In an embodiment, the first cushion body 1 is made of a sponge body with a density of 25 to 60 kg/m³, and the second cushion body 2 is made of a memory form body with a density of 30to 100 kg/m³. The sponge body has certain hardness and resilience, which can provide good support, so that the composite cushion can generate a good supporting force with the first cushion body 1. The memory form body is soft in material, which can fit a whole contact surface, with good contact comfort of users.

When the first cushion body 1 can be a sponge body with a density of 25 kg/m³, with a 65% indentation hardness of 200 N. The second cushion body 2 can be a memory form body with a density of 30 kg/m³, with a 65% indentation hardness of 80 N. A 65% indentation hardness of the composite cushion formed by foaming and forming with a thickness ratio of 1:1.5 is 120 N.

When the first cushion body 1 can be a sponge body with a density of 60 kg/m³, with a 65% indentation hardness of 850 N. The second cushion body 2 can be a memory form body with a density of 100 kg/m³, with a 65% indentation hardness of 200 N. A 65% indentation hardness of the composite cushion formed by foaming and forming with a thickness ratio of 1:1.5 is 500 N.

In an embodiment, the first cushion body 1 is made of a sponge body with a density of 25 to 60 kg/m³, and the second cushion body 2 is made of a latex-imitated sponge body with a density of 30 to 100 kg/m³. The sponge body provides support, and the latex-imitated sponge body is soft in material, with high elasticity, comfort and durability.

When the first cushion body 1 can be a sponge body with a density of 25 kg/m³, with a 65% indentation hardness of 200 N. The second cushion body 2 can be a latex-imitated sponge body of 30 kg/m³, with a 65% indentation hardness of 65 N. A 65% indentation hardness of the composite cushion formed by foaming and forming with a thickness ratio of 1:1.5 is 100 N.

When the first cushion body 1 can be a sponge body with a density of 60 kg/m³, with a 65% indentation hardness of 850N. The second cushion body 2 can be a latex-imitated sponge body of 100 kg/m³, with a 65% indentation hardness of 180N. A 65% indentation hardness of the composite cushion formed by foaming and forming with a thickness ratio of 1:1.5 is 400N.

In the above two embodiments, the second cushion body 2 is integrally formed with the wrapping sealing edge 21 by foaming. The wrapping sealing edge 21 is bent in a direction towards a middle to form a wrapping cavity with an opening larger than an inner cavity 22. The first cushion body 1 is located in the wrapping cavity 22, and the second cushion body 2 is configured to wrap the first cushion body 1. The first cushion body 1 is wrapped through a bending structure of the wrapping sealing edge 21, so that an integrated structure between the first cushion body 1 and the second cushion body 2 is more firm and reliable. The first cushion body 1 and the second cushion body 2 are integrally formed in a foaming manner, with good integrity and no adhesive for bonding, which is safe, odorless and environment-friendly.

A thickness of the sponge is one-third to six out of seven of an overall thickness of the composite cushion. The first cushion body 1 can give enough support, and at the same time, it also shapes an overall shape of the composite cushion, so that the composite cushion is not easy to deform and fail after long-term use on a premise of satisfying comfort.

Referring to FIGS. 1 to 4, a cushion forming mold 3 is further provided in the disclosure, which is configured for forming the composite cushion described above. The composite cushion mold 3 includes an upper mold 31 and a lower mold 32. A middle part of an upper side of the lower mold 32 is recessed inward to form an accommodating cavity 321, a lower side of the upper mold 31 is provided with a ring of convex parts 311 with an irregular annular structure, and the convex part 311 is matched with an opening of the accommodating cavity 321 to form a closed cavity for foaming. The upper mold 31 and/or the lower mold 32 are fixedly provided with a plurality of positioning members 33, and when the upper mold 31 and the lower mold 32 are covered, the plurality of positioning members 33 are located in the accommodating cavity 321. After a preformed first cushion body 1 is inserted and positioned on the positioning members 33, the second cushion body 2 is foamed, and the formed second cushion body 2 can form an integrated structure with the first cushion body 1 uniformly.

The plurality of positioning members 33 are symmetrically and oppositely arranged in pairs, and the first cushion body can be inserted on the positioning members 33 in a balanced and stable manner. The positioning members 33 are arranged to fix the first cushion body 1, so that the impact force when the foaming material for the second cushion body 2 is foamed may not cause the first cushion body 1 in the accommodating cavity 321 to be irregularly displaced, thereby ensuring that the formed second cushion body 2 can be evenly distributed on a surface of the first cushion body 1.

The opening of the accommodating cavity 321 is provided with a smooth introduction surface 322 that expands outward, and an outer edge of the convex part 311 is a smooth insertion surface 312 that tapers inward, so that the convex part 311 can quickly and smoothly seal the opening of the accommodating cavity 321, which also facilitates formation of an interference fit structure between the introduction surface 322 and the insertion surface 312 so as to ensure sealing.

The lower side of the upper mold 31 and the upper side of the lower mold 32 are also respectively provided with an inserting post 313 and an inserting slot 323 for assisting in positioning and fixing. A structure provided with the inserting post 313 and the inserting slot 323 can be further positioned, so that the upper mold 31 and the lower mold 32 will not be displaced due to the impact force during the foaming, thus preventing the foaming material from overflowing and affecting product quality.

The inserting post 313 is a structure tapered towards its free end and the inserting slot 323 is a structure expanded towards its notch, which facilitates quick positioning between the inserting post 313 and the inserting slot 323.

The above is only preferred embodiments of the present disclosure, which does not limit a protection scope of the present disclosure. Any equivalent transformation made with the specification of the present disclosure, which is directly or indirectly applied to other related technical fields, is included within the scope of the disclosure.

1. A composite cushion, comprising a first cushion body and a second cushion body, wherein the second cushion body is provided with a wrapping sealing edge, and the wrapping sealing edge is bent in a direction towards a middle to form a wrapping cavity with an opening larger than an inner cavity, the first cushion body is located in the wrapping cavity, and the second cushion body is configured to wrap the first cushion body; and the first cushion body and the second cushion body are integrally formed in a foaming manner, and materials and/or densities of the first cushion body and the second cushion body are different.

2. The composite cushion according to claim 1, wherein the first cushion body is a sponge body and the second cushion body is a memory form body.

3. The composite cushion according to claim 2, wherein a density of the sponge body is 25 to 60 kg/m³ and a density of the memory form body is 30 to 100 kg/m³.

4. The composite cushion according to claim 3, wherein a thickness of the sponge is one-third to six out of seven of a thickness of the composite cushion.

5. The composite cushion according to claim 1, wherein the first cushion body is a sponge body, and the second cushion body is a latex-imitated sponge body.

6. The composite cushion according to claim 5, wherein a density of the sponge body is 25 to 60 kg/m³ and a density of the latex-imitated sponge body is 30 to 100 kg/m³.

7. The composite cushion according to claim 6, wherein a thickness of the sponge is one-third to six out of seven of a thickness of the composite cushion.

8. The composite cushion according to claim 1, wherein the second cushion body is integrally formed with the wrapping sealing edge by foaming.

9. The composite cushion according to claim 8, wherein a folding width of the wrapping sealing edge is uniform.

10. A cushion forming mold for forming a composite cushion, comprising an upper mold and a lower mold, wherein a middle part of an upper side of the lower mold is recessed inward to form an accommodating cavity, a lower side of the upper mold is provided with a convex part which is matched with an opening of the accommodating cavity to form a closed cavity for foaming, and the upper mold and/or the lower mold are provided with a plurality of positioning members located in the accommodating cavity;
wherein the composite cushion comprises a first cushion body and a second cushion body, and materials and/or densities of the first cushion body and the second cushion body are different; and
before the second cushion body is foamed and formed, the first cushion body is inserted on the plurality of positioning members for positioning in advance, and a gap is left between the first cushion body and an inner wall of the accommodating cavity, and the second cushion body is formed at the gap by foaming, thus forming an integrated structure that wraps the first cushion body; and the second cushion body is provided with a wrapping sealing edge, and the wrapping sealing edge is bent in a direction towards a middle to form a wrapping cavity with an opening larger than an inner cavity.

11. The composite cushion according to claim 10, wherein the convex part is an irregular annular structure adapted to the opening of the accommodating cavity, and the plurality of positioning members are fixedly arranged on the lower side of the upper mold and are located in a ring of the convex part.

12. The composite cushion according to claim 10, wherein the opening of the accommodating cavity is provided with a smooth introduction surface that expands outward, and an outer edge of the convex part is a smooth insertion surface that tapers inward.

13. The composite cushion according to claim 10, wherein the plurality of positioning members is symmetrically and oppositely arranged in pairs.

14. The composite cushion according to claim 10, wherein the lower side of the upper mold and the upper side of the lower mold are also respectively provided with an inserting post and an inserting slot for assisting in positioning and fixing.

15. The composite cushion according to claim 14, wherein the inserting post is a structure tapered towards its free end and the inserting slot is a structure expanded towards its notch.

16. The composite cushion according to claim 10, wherein the first cushion body is a sponge body and the second cushion body is a memory form body.

17. The composite cushion according to claim 16, wherein a density of the sponge body is 25 to 60 kg/m³ and a density of the memory form body is 30 to 100 kg/m³.

18. The composite cushion according to claim 10, wherein the first cushion body is a sponge body, and the second cushion body is a latex-imitated sponge body.

19. The composite cushion according to claim 18, wherein a density of the sponge body is 25 to 60 kg/m³ and a density of the latex-imitated sponge body is 30 to 100 kg/m³.
